(19) United States
(12) Patent Application Publication
(10) Pub. No.: US 2015/0167718 A1
(43) Pub. Date: Jun. 18, 2015

(54) ALIGNMENT SYSTEM FOR PROVIDING ALIGNMENT OF COMPONENTS HAVING CONTOURED FEATURES

(71) Applicant: GM Global Technology Operations LLC, Detroit, MI (US)

(72) Inventors: Steven E. Morris, Fair Haven, MI (US); Jennifer P. Lawall, Waterford, MI (US)

(73) Assignee: GM Global Technology Operations LLC, Detroit, MI (US)

(21) Appl. No.: 14/104,549

(22) Filed: Dec. 12, 2013

(51) Int. Cl. F16B 21/07

(52) U.S. Cl. CPC F16B 21/071

(57) ABSTRACT

An elastically averaged alignment system includes a first component having a first alignment member and first and second elastically deformable alignment elements, and a second component having a second alignment member and first and second alignment features. The first and second alignment elements are configured and disposed to interferingly, deformably and matingly engage with respective ones of the first and second alignment features. The first alignment feature includes an elongated aperture having a first direction of elongation, and the second alignment feature includes an elongated aperture having a second direction of elongation that is oriented differently from the first direction of elongation. Portions of the first and second alignment elements when inserted into respective ones of the first and second alignment features elastically deform to an elastically averaged final configuration that aligns the first component relative to the second component in at least two of four planar orthogonal directions.

### FIELD OF THE INVENTION

The subject invention relates to the art of alignment systems, more particularly to an elastically averaged alignment system, and even more particularly to an elastically averaged alignment system providing alignment of mating parts having contoured features and on which the alignment system is incorporated.

### BACKGROUND

Currently, components, particularly vehicular components such as those found in automotive vehicles, which are to be mated together in a manufacturing process are mutually located with respect to each other by alignment features that are oversized and/or undersized to provide spacing to freely move the components relative to one another to align them without creating an interference therebetween that would hinder the manufacturing process. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components having the aforementioned alignment features, which may contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality.

Additionally, the alignment of first and second components having corresponding contoured mating edges may result in the inner edge of the second component being interferingly biased against the outer edge of a first component if the first component builds short and/or the second component builds long (or vice-versa depending on the profile of the contoured edges), which may result in an undesirable squeaky assembly or an assembly having a non-uniform fit.

Accordingly, the art of alignment systems can be enhanced by providing an alignment system or mechanism that can compensate for a manufacturing process where the first component builds short and/or the second component builds long via elastic averaging of a pair of elastically deformable alignment elements disposed in mating engagement with a corresponding pair of alignment features that slightly biases apart the mating components.

### SUMMARY OF THE INVENTION

In one exemplary embodiment of the invention an elastically averaged alignment system includes a first component having a first alignment member and first and second elastically deformable alignment elements fixedly disposed with respect to the first alignment member, and a second component having a second alignment member and first and second alignment features fixedly disposed with respect to the second alignment member. The first and second elastically deformable alignment elements are configured and disposed to interferingly, deformably and matingly engage with respective ones of the first and second alignment features. The first alignment feature includes an elongated aperture having a first direction of elongation, and the second alignment feature includes an elongated aperture having a second direction of elongation, the second direction of elongation being oriented differently from the first direction of elongation. Portions of the first and second elastically deformable alignment elements when inserted into respective ones of the first and second alignment features elastically deform to an elastically averaged final configuration that aligns the first component relative to the second component in at least two of four planar orthogonal directions.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a front plan view of an assembly of a first component aligned and with a second component via an elastically averaged alignment system, in accordance with an embodiment of the invention;

FIG. 2 depicts a perspective view of a portion of the assembly of FIG. 1;

FIG. 3 depicts a rear plan view of the assembly of FIG. 1;

FIG. 4 depicts a rear plan view of a portion of the assembly of FIG. 3;

FIG. 5 depicts a rear plan view similar but alternative to that of FIG. 4, in accordance with an embodiment of the invention;

FIG. 6 depicts a rear plan view alternative to that of FIG. 4, in accordance with an embodiment of the invention;

FIG. 7 depicts a portion of FIG. 6 with mating parts arranged in a non-interfering manner, in accordance with an embodiment of the invention;

FIG. 8 depicts the portion of FIG. 7 with the mating parts arranged in an interfering manner, in accordance with an embodiment of the invention; and

FIG. 9 depicts a front plan view of a dashboard of a vehicle having the assembly of FIG. 1.

### DESCRIPTION OF THE EMBODIMENTS

The following description is merely exemplary in nature and is not intended to limit the present disclosure, its application or uses. For example, the embodiments shown comprise vehicle components but the alignment system may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, now U.S. Publication No. U.S. 2013-0019455, the disclosure of which is incorporated by reference herein in its entirety. The embodiments disclosed above provide the ability to convert an existing component that is not compatible with the above-described elastic averaging principles, or that would be further aided with the inclusion of an elastically averaged alignment system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled, towed, or movable conveyance suitable for transporting or supporting a burden.

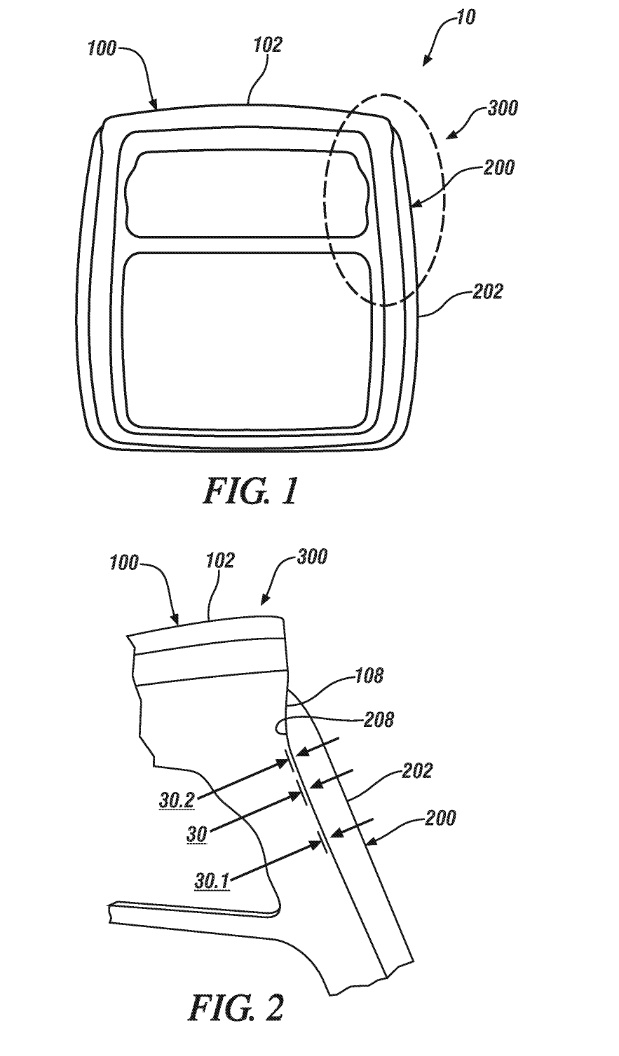

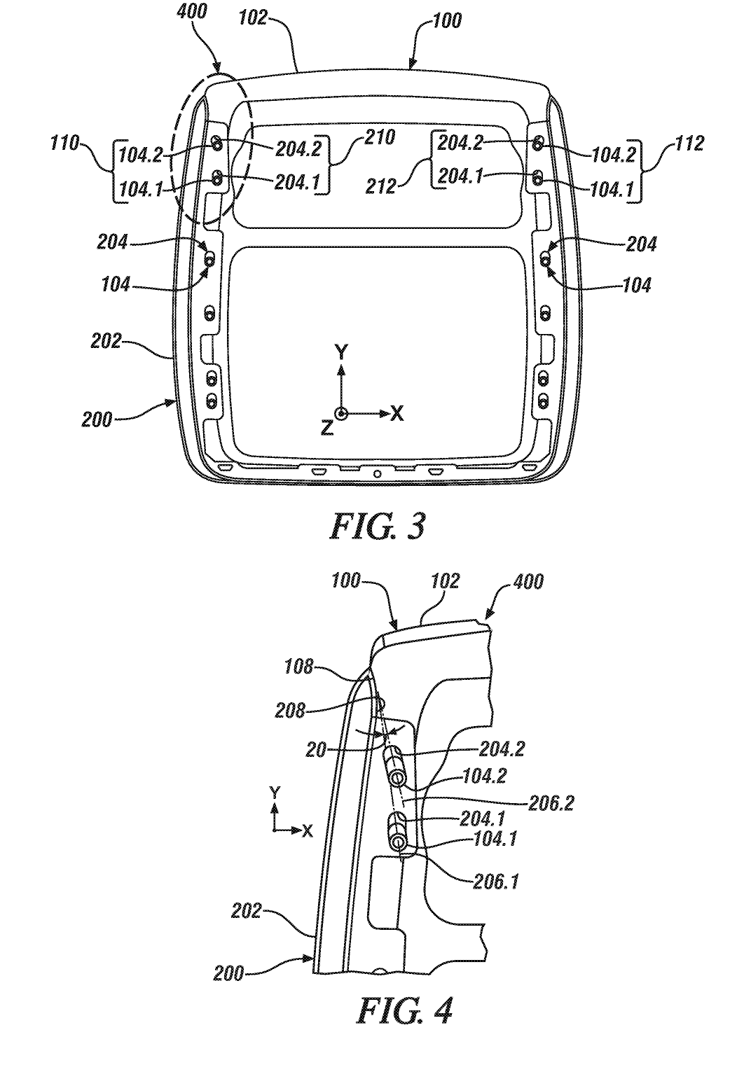

Reference is now made to FIGS. 1-4, where FIG. 1 depicts a front plan view of an elastically averaged alignment system 10 that includes a first component 100 having a first alignment member 102 and a second component 200 having a second alignment member 202, FIG. 2 depicts a perspective view of detail 300 denoted in FIG. 1, FIG. 3 depicts a rear plan view of the elastically averaged alignment system 10 of FIG. 1 that includes the rear view of detail 300 of FIG. 2, and FIG. 4 depicts a rear plan view of detail 400 denoted in FIG. 3, all in accordance with an embodiment of the invention.

With reference now specifically to FIG. 4, the first component 100 includes first and second elastically deformable alignment elements 104.1, 104.2 fixedly disposed with respect to the first alignment member 102, and the second component 200 includes first and second alignment features 204.1, 204.2 fixedly disposed with respect to the second alignment member 202. The plurality of elastically deformable alignment elements and alignment features depicted in FIG. 3 are herein referred to collectively by reference numerals 104, 204, respectively. The first and second elastically deformable alignment elements 104.1, 104.2 are configured and disposed to interferingly, deformably and matingly engage with respective ones of the first and second alignment features 204.1, 204.1, as depicted in FIG. 4 for example. In an embodiment, each of the first and second elastically deformable alignment elements 104.1, 104.2 is integrally formed with the first component 100 in the shape of a hollow tube having a circular cross-section (also herein referred to by reference numerals 104.1, 104.2), and each of the first and second alignment features 204.1, 204.2 includes an elongated aperture (also herein referred to by reference numerals 204.1, 204.2) having a major axis 206.1, 206.2 and a minor axis (not enumerated but understood to be orthogonal to the respective major axis), where the major axis 206.2 of the second alignment feature 204.2 is oriented at an angle 20 that is non-parallel and non-perpendicular to the major axis 206.1 of the first alignment feature 204.1. Portions of the first and second elastically deformable alignment elements 104.1, 104.2 when inserted into respective ones of the first and second alignment features 204.1, 204.2 elastically deform to an elastically averaged final configuration that aligns the first alignment member 102 with the second alignment member 202, and the first component 100 relative to the second component 200, in at least two of four planar orthogonal directions, such as the +/− x-direction and/or the +/− y-direction of an orthogonal coordinate system, for example (see x-y-z coordinate system depicted in FIG. 3 for example). Alignment of the first and second alignment members 102, 202 in two planar orthogonal directions is herein referred to as two-way alignment, and in four planar orthogonal directs is herein referred to as four-way alignment.

In an embodiment, the first component 100 forms a decorative face for a portion of a dashboard 500 of a vehicle (depicted in FIG. 9 for example), such as a portion of the dashboard media center for example, and the second component 200 forms a decorative trim that is disposed at least partially around an outer perimeter of the first component 100, as depicted in FIGS. 1 and 9 for example. While not being limited to any particular method of manufacture, an embodiment includes a manufacturing method of plastic injection molding for forming the first and second components 100, 200. With plastic injection molding, it is well known that dimensional variations of each mating part, the first and second components 100, 200 for example, can vary for a variety of reasons, such as cavity-to-cavity dimensional variations in a multi-cavity mold, mold-to-mold dimensional variations where multiple molds are employed, molding processes that result in part dimensional variations toward the high side of a dimensional tolerance range, molding processes that result in part dimensional variations toward the low side of a dimensional tolerance range, and material characteristics from one batch of injection moldable material to another that produces different material shrinkage factors in the molded and cured part, for example. A molded part that is formed on the high side of the tolerance range is herein referred to as having been built long, and a molded part that is formed on the low side of the tolerance range is herein referred to as having been built short.

As can be seen from FIG. 4, when the first component 100 is built short, reduced dimension in the +/− y-direction, and/or the second component 200 is built long, enlarged dimension in the +/− y-direction, the contoured edge 208 of the second component 200 (herein referred to as a second contoured edge 208) will tend to push into the contoured edge 108 of the first component 100 (herein referred to as a first contoured edge 108), absent elastically averaged alignment which will be described in more detail below. If the contoured edges 108, 208 are permitted to engage each other, undesirable squeaking may occur if the first and second components 100, 200 vibrate relative to each other.

With reference still to FIG. 4, when the first component 100 is built short and/or the second component 200 built long, the portion of the second alignment member 202 proximate the first elongated aperture 204.1 will move relative to the first hollow tube 104.1 in a direction defined by the major axis 206.1 of the first elongated aperture 204.1, and the portion of the second alignment member 202 proximate the second elongated aperture 204.2 will move relative to the second hollow tube 104.2 in a direction defined by the major axis 206.2 of the second elongated aperture 204.2. Since the two major axes 206.1, 206.2 are misaligned by the angle 20, the end result will be for the contoured edge 208 of the second alignment member 202 to be elastically biased away from the contoured edge 108 of the first alignment member 102, thereby avoiding edge-to-edge engagement of the mating parts and undesirable squeaking

With reference back to FIG. 2, it can be seen that the second contoured edge 208 is configured in a corresponding relationship with the first contoured edge 108 with a defined gap 30 between the first and second contoured edges 108, 208. When the first component 100 is built short and/or the second component 200 built long, as described above, the defined gap proximate the second hollow tube 104.2 (enumerated herein by reference numeral 30.2) is designed to be equal to or greater than the defined gap proximate the first hollow tube 104.1 (enumerated herein by reference numeral 30.1).

While reference is made herein to contoured edges 108, 208 depicted with non-linear contours, it will be appreciated that the scope of the invention is not limited to mating components having only non-linear contoured edges, but also applies to mating components have linearly shaped edges that are angularly oriented relative to each other such that one edge is biased toward a second edge when one mating component is built short and/or the other built long. Any edge shape may benefit from the invention disclosed herein, and all such edge shapes are contemplated and considered to fall within the ambit of the invention disclosed herein.

With reference back to FIG. 3, an embodiment includes a symmetrical arrangement where the first component 100 has a first pair 110 and a symmetrically opposed second pair 112 of the first and second elastically deformable alignment elements 104.1, 104.2, and the second component 200 has a first pair 210 and a symmetrically opposed second pair 212 of the first and second alignment apertures 204.1, 204.2. The respective pairs 110, 112 of the elastically deformable alignment elements are geometrically distributed with respect to respective pairs 210, 212 of the alignment apertures, such that portions of each elastically deformable alignment element 104.1, 104.2 of respective ones of the pairs 110, 112 of elastically deformable alignment elements, when engaged with respective ones of the pairs 210, 212 of alignment apertures, elastically deform to an elastically averaged final configuration that further aligns the first alignment member 102 with the second alignment member 202 in at least two of four planar orthogonal directions.

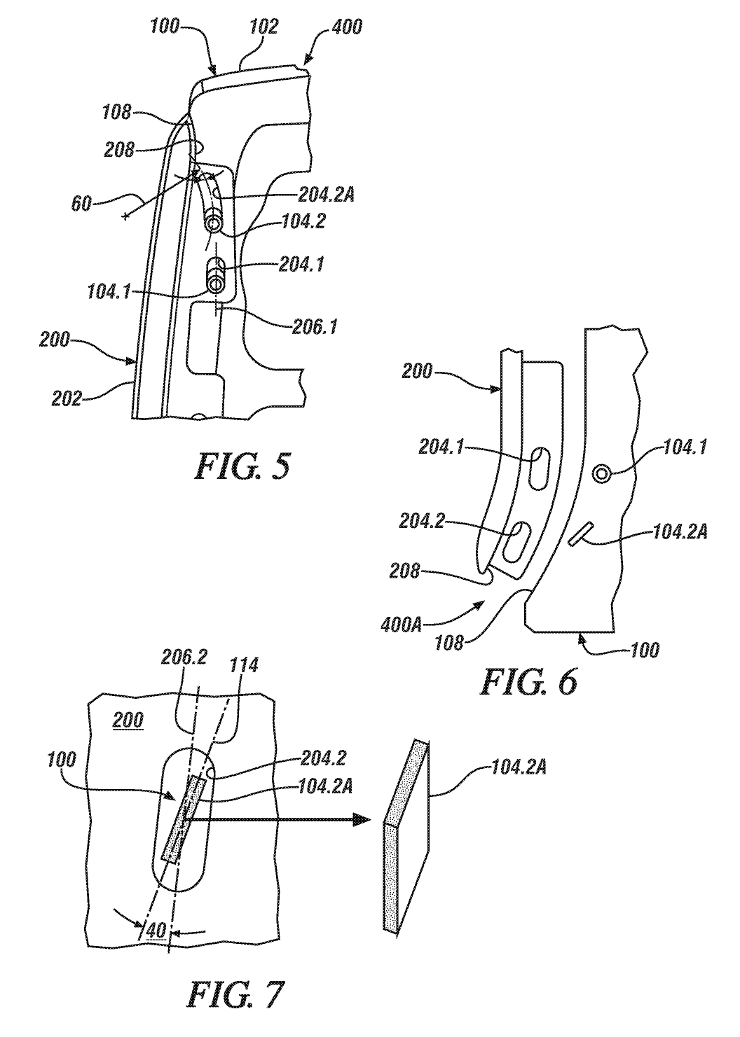

While an embodiment of the invention has been described herein having two elongated alignment apertures 204.1, 204.2 aligned with respective major axes 206.1, 206.2 having an angle 20 therebetween to control the alignment of the contoured surfaces 108, 208, it will be appreciated that the scope invention is not so limited, and also encompasses an embodiment where the second alignment aperture 204.2 is contoured itself relative to the contour of the contoured edges 108, 208, which will now be described with reference to FIG. 5.

FIG. 5 depicts a rear plan view of a portion of the first and second components 100, 200 similar to that of FIG. 4, but with a second elongated alignment aperture 204.2A having a contoured elongated shape that follows a radius of curvature 60, such that as the first component 100 is built short and/or the second component 200 built long, the portion of the second alignment member 202 proximate the first elongated aperture 204.1 will move relative to the first hollow tube 104.1 in a direction defined by the major axis 206.1 of the first elongated aperture 204.1, and the portion of the second alignment member 202 proximate the second elongated aperture 204.2A will move relative to the second hollow tube 104.2 in a direction defined by the radius of curvature 60 of the second elongated aperture 204.2A. The end result will be for the contoured edge 208 of the second alignment member 202 to be elastically biased away from the contoured edge 108 of the first alignment member 102, thereby avoiding edge-to-edge engagement of the mating parts and undesirable squeaking.

In view of the embodiments depicted in FIGS. 4 and 5, it will be appreciated that an embodiment of the invention can be described as including a first alignment feature in the form of an elongated aperture 204.1 having a first direction of elongation 206.1, and a second alignment feature in the form of an elongated aperture 204.2, 204.2A having a second direction of elongation 206.2, 60, respectively, where the second direction of elongation 206.2, 60 is oriented differently from the first direction of elongation 206.1, such that when the first component 100 is built short and/or the second component 200 built long, the contoured edge 208 will be elastically biased away from the contoured edge 108. In an embodiment, the second direction of elongation 206.2, 60 is oriented non-parallel and non-perpendicular to the first direction of elongation 206.1.

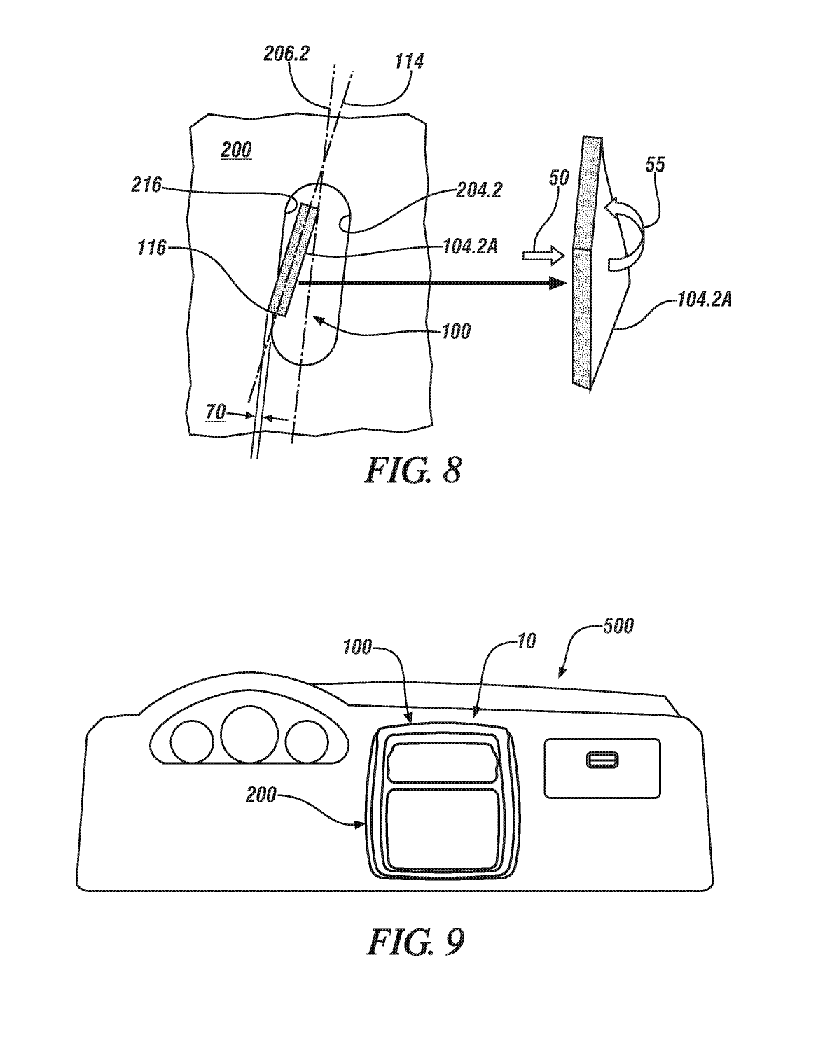

While an embodiment of the invention has been described herein employing a circular hollow tube for the second elastically deformable alignment element 104.2 disposed proximate the contoured edges 108, 208 of the first and second alignment members 102, 202, respectively, it will be appreciated that the scope of the invention is not so limited and also extends to other shapes that can be used to form an elastically deformable alignment element, which will now be described in connection with FIGS. 6-8, where FIG. 6 depicts a disassembled assembly of a portion 400A (comparable to detail 400 of FIG. 4) of the first and second components 100, 200 having an alternative second elastically deformable alignment element 104.2A, FIG. 7 depicts the alternative second elastically deformable alignment element 104.2A in a non-interfering relationship with the elongated aperture 204.2, and FIG. 8 depicts the alternative second elastically deformable alignment element 104.2A in an interfering relationship 70 with the elongated aperture 204.2.

In an embodiment, the alternative second elastically deformable alignment element 104.2A is a projection or tab having a rectangular cross-section (also herein referred to by reference numeral 104.2A), and in an embodiment is a solid rectangular tab.

With reference still to FIGS. 6-8, When the first and second components 100, 200 do not build short or long with respect to each other, there is no need for the contoured edge 208 of the second component 200 to be biased away from the contoured edge 108 of the first component 100, as the aforementioned gap 30 depicted in FIG. 2 will be controlled by the plurality of elastically deformable alignment elements 104 and alignment features 204 as depicted in FIG. 3. Such a condition is represented in FIG. 7, where the elastically deformable alignment element (rectangular projection) 104.2A is in a non-interfering relationship with the elongated aperture 204.2 and is not elastically deformed, which is depicted by the perspective view of the rectangular projection 104.2A on the right side of FIG. 7.

As depicted in FIG. 7, the rectangular projection 104.2A has a major axis 114 that is misaligned with the major axis 206.2 of elongated aperture 204.2 by an angle 40, the purpose of which will become evident with reference to FIG. 8.

With reference now to FIG. 8 in combination with FIG. 6, when the first component 100 builds short and/or the second component 200 builds long, the aforementioned misaligned axes 114, 206.2 causes an end 116 of the rectangular projection 104.2A to be driven into a sidewall 216 of the elongated aperture 204.2. The resulting force 50 exerted on the end 116 of the rectangular projection 104.2A by the sidewall 216 of the elongated aperture 204.2 causes the elastically deformable rectangular projection 104.2A to twist 55, which is depicted by the perspective view of the elastically deformed rectangular projection 104.2A on the right side of FIG. 8. The resulting action and reaction caused by force 50 between the end 116 of the rectangular projection 104.2A and the sidewall 216 of the elongated aperture 204.2 causes the contoured edge 208 of the second component 200 to be biased away from the contoured edge 108 of the first component, thereby avoiding edge-to-edge engagement of the mating parts and undesirable squeaking.

By comparing the embodiment depicted in FIGS. 6-8 with the embodiments depicted in FIGS. 4 and 5, it will be appreciated that the rectangular projection 104.2A may be employed with either the elongated aperture 204.2 or the contoured elongated aperture 204.2A for a purpose disclosed herein.

As previously mentioned, in some embodiments the first component 100 may have more than one elastically deformable alignment element 104, and the second component 200 may have more than one corresponding alignment feature 204, depending on the requirements of a particular embodiment, where the plurality of elastically deformable alignment elements 104 are geometrically distributed in coordinated relationship to a geometrical distribution of the plurality of alignment features 204 such that each elastically deformable alignment element 104 is receivable into a respective alignment feature 204, as illustrated in FIG. 3.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system, comprising:
a first component comprising a first alignment member and first and second elastically deformable alignment elements fixedly disposed with respect to the first alignment member;
a second component comprising a second alignment member and first and second alignment features fixedly disposed with respect to the second alignment member;
wherein the first and second elastically deformable alignment elements are configured and disposed to interferingly, deformably and matingly engage with respective ones of the first and second alignment features;
wherein the first alignment feature comprises an elongated aperture having a first direction of elongation, and the second alignment feature comprises an elongated aperture having a second direction of elongation, the second direction of elongation being oriented differently from the first direction of elongation; and
wherein portions of the first and second elastically deformable alignment elements when inserted into respective ones of the first and second alignment features elastically deform to an elastically averaged final configuration that aligns the first component relative to the second component in at least two of four planar orthogonal directions.

2. The elastically averaged alignment system of claim 1, wherein each of the first and second alignment features comprises an elongated aperture having a major axis and a minor axis, the major axis of the second alignment feature being oriented at an angle that is non-parallel and non-perpendicular to the major axis of the first alignment feature.

3. The elastically averaged alignment system of claim 1, wherein at least one of the first and second alignment features comprises a contoured elongated aperture having a direction of elongation defined by a radius of curvature.

4. The elastically averaged alignment system of claim 1, wherein the first component comprises more than one pair of the first and second elastically deformable alignment elements and the second component comprises more than one pair of the first and second alignment apertures, the more than one pair of elastically deformable alignment elements being geometrically distributed with respect to respective ones of the more than one pair of alignment apertures, such that portions of the elastically deformable alignment element of respective ones of the more than one pair of elastically deformable alignment elements, when engaged with respective ones of the more than one pair of alignment apertures, elastically deform to an elastically averaged final configuration that further aligns the first component relative to the second component in at least two of four planar orthogonal directions.

5. The elastically averaged alignment system of claim 1, wherein at least one of the first and second elastically deformable alignment elements comprises a hollow tube having a circular cross-section.

6. The elastically averaged alignment system of claim 1, wherein at least one of the first and second elastically deformable alignment elements comprises an elastically deformable projection having a rectangular cross-section.

7. The elastically averaged alignment system of claim 1, wherein the first elastically deformable alignment element comprises a hollow tube having a circular cross-section, and the second elastically deformable alignment element comprises a projection having a rectangular cross-section.

8. The elastically averaged alignment system of claim 6, wherein the elastically deformable rectangular projection comprises a solid elastically deformable rectangular projection.

9. The elastically averaged alignment system of claim 1, wherein the first elastically deformable alignment element when interferingly engaged with the first alignment feature, and wherein the second elastically deformable alignment element when interferingly engaged with the second alignment feature, elastically biases at least a portion of the second alignment member away from the first alignment member.

10. The elastically averaged alignment system of claim 1, wherein the first component comprises a first contoured edge, and the second component comprises a second contoured edge configured in a corresponding relationship with the first contoured edge with a defined gap between the first and second contoured edges.

11. The elastically averaged alignment system of claim 10, wherein the defined gap proximate the second elastically deformable alignment element is equal to or greater than the defined gap proximate the first elastically deformable alignment element.

12. The elastically averaged alignment system of claim 10, wherein the first contoured edge comprises a first non-linear contoured edge, and the second contoured edge comprises a second non-linear contoured edge.

13. The elastically averaged alignment system of claim 1, wherein the second component is disposed at least partially around an outer perimeter of the first component.

14. The elastically averaged alignment system of claim 6, wherein the elastically deformable rectangular projection has a major axis that is non-parallel and non-perpendicular to the major axis of the second alignment feature.

15. The elastically averaged alignment system of claim 14, wherein the first elastically deformable alignment element when interferingly engaged with the first alignment feature, and wherein the elastically deformable rectangular projection when interferingly engaged with the second alignment feature, elastically biases at least a portion of the second alignment member away from the first alignment member.

16. The elastically averaged alignment system of claim 15, wherein the elastically deformable rectangular projection is elastically deformed in a twisted manner.

17. The elastically averaged alignment system of claim 1, wherein:
the first component comprises a first portion of a vehicle; and
the second component comprises a second portion of the vehicle.
